(19) United States
(12) Patent Application Publication
(10) Pub. No.: US 2011/0025678 A1
(43) Pub. Date: Feb. 3, 2011

(54) ORGANIC LIGHT EMITTING DISPLAY DEVICE AND DRIVING METHOD THEREOF

(75) Inventor: Ho-Ryun Chung, Yongin-city (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung Mobile Display Co., Ltd., Yongin-city (KR)

(21) Appl. No.: 12/710,627

(22) Filed: Feb. 23, 2010

(30) Foreign Application Priority Data
Jul. 29, 2009 (KR) 10-2009-0069424

(51) Int. Cl. G06F 3/038

(52) U.S. Cl. 345/213; 345/82

(57) ABSTRACT

An organic light emitting display device is disclosed. The device includes a data driver for supplying a plurality of data signals and a reset voltage to each output line during every horizontal period. The data driver is configured to selectively supply the reset signal and the reset voltage based on a comparison of the data signal input to each data line during a current horizontal period with the data signal input to the data lines during the previous horizontal period.

### CROSS-REFERENCE TO RELATED APPLICATIONS

This application claims priority to and the benefit of Korean Patent Application No. 10-2009-0069424, filed on Jul. 29, 2009, in the Korean Intellectual Property Office, the entire content of which is incorporated herein by reference.

### BACKGROUND

1. Field

The field relates to an organic light emitting display device, and more particularly, to an organic light emitting display device, wherein a threshold voltage compensation circuit is provided for each pixel, so that the number of output lines in a data driver can be decreased, and sufficient driving time can be secured.

2. Description of the Related Technology

Various types of flat panel display devices having reduced weight and volume as compared with cathode ray tubes have been developed. The flat panel display devices include a liquid crystal display device (LCD), a field emission display device (FED), a plasma display panel (PDP), an organic light emitting display device (OLED), and the like.

The OLED displays images by using organic light emitting diodes that emit light through recombination of electrons and holes. The OLED has a fast response speed and is driven with low power consumption.

Generally, OLEDs are classified as passive matrix OLED (PMOLED) and an active matrix OLED (AMOLED), depending on a method of driving the organic light emitting diodes.

The AMOLED includes a plurality of scan lines, a plurality of data lines, a plurality of power lines and a plurality of pixels connected to these lines and arranged in a matrix form. Each of the pixels typically includes an organic light emitting diode; two transistors, i.e., switching transistors for transmitting a data signal; a driving transistor for driving the organic light emitting diode in accordance with the data signal; and a capacitor for maintaining the voltage of the data signal.

Such an AMOLED has low power consumption as described above. However, in the AMOLED, the intensity of current flowing through an organic light emitting diode depends on a voltage between gate and source electrodes of a driving transistor for driving the organic light emitting diode. Accordingly, differences between threshold voltages of the numerous driving transistors, causes display non-uniformity.

That is, since characteristics of the driving transistor in each of the pixels depend on manufacturing process variables, it is difficult to manufacture transistors so that all the transistors of the AMOLED have the same characteristics. Therefore, there exists a difference of threshold voltages between the pixels.

In a related art AMOLED, pixels are positioned at intersection portions of the scan and data lines, respectively, and a data driver is provided with output lines having a number corresponding to the number of data lines so that data signals can be supplied to the data lines, respectively. To this end, the data driver necessarily includes a large number of data driving circuits, and therefore, manufacturing cost is large. Particularly, as the resolution and size of a pixel unit is increased, the number of output lines of the data driver is increased. Therefore, the manufacturing cost is also increased.

### SUMMARY OF CERTAIN INVENTIVE ASPECTS

One aspect is an organic light emitting display, including a data driver configured to supply a plurality of data signals and a reset voltage to each of a plurality of output lines, and a plurality of demultiplexers connected to the output lines and a plurality of data lines. Each of the output lines correspond to a plurality of the data lines, and each of the demultiplexers has a plurality of switching elements configured to connect each output line to the corresponding data lines. The display also includes a demultiplexer controller configured to supply a plurality of control signals and to selectively supply a reset signal to the demultiplexers, the plurality of control signals allowing the data signals of an output line to be applied to the corresponding data lines by sequentially turning on the switching elements, and the reset signal allowing the reset voltage of an output line to be applied to the corresponding data lines by simultaneously turning on the plurality of switching elements. The display also includes a scan driver configured to sequentially supply scan signals to scan lines for each of a plurality of horizontal periods, and a plurality of pixels coupled to the data and scan lines, where the reset signal is selectively supplied to the demultiplexers based at least in part on a comparison of a data signal input to a data line during a current horizontal period with a data signal input to the data line during a previous horizontal period.

Another aspect is a method of driving an organic light emitting display device, the method including applying a reset voltage through each of a plurality of output lines during a horizontal period to supply a reset voltage to a plurality of data lines corresponding to each output line. The method also includes initializing a plurality of parasitic capacitors on the data lines with the reset voltage, sequentially applying a plurality of data signals through each of the output lines to the plurality of corresponding data lines during the horizontal period after initializing the parasitic capacitors, storing voltages corresponding to the data signals in respective pixels coupled to the plurality of data lines during a period when a scan signal is supplied to a current scan line, and allowing the pixels to emit light corresponding to the charged voltages. The reset voltage is selectively supplied to the data lines based at least in part on a comparison of a data signal input to a data line during a current horizontal period with a data signal input to the data line during a previous horizontal period.

Another aspect is an organic light emitting display, including a data driver configured to supply a plurality of data signals and a reset voltage to each of a plurality of data lines during a horizontal period. The reset signal is selectively supplied to the data lines based at least in part on a comparison of a data signal input to a data line during a current horizontal period with a data signal input to the data line during a previous horizontal period.

### BRIEF DESCRIPTION OF THE DRAWINGS

The accompanying drawings, together with the specification, illustrate exemplary embodiments, and, together with the description, serve to explain various inventive aspects.

FIG. 1 is a block diagram of an organic light emitting display device according to one embodiment.

FIG. 2 is a circuit diagram of an embodiment of a demultiplexer illustrated in FIG. 1.

FIG. 3 is a circuit diagram illustrating an embodiment of a pixel illustrated in FIG. 1.

FIG. 4 is a waveform diagram illustrating a driving method of an organic light emitting display device according to an embodiment

FIG. 5 is a circuit diagram illustrating in detail the connection structure of demultiplexers and pixels according to an embodiment.

### DETAILED DESCRIPTION OF CERTAIN INVENTIVE EMBODIMENTS

Hereinafter, certain exemplary embodiments will be described with reference to the accompanying drawings. Here, when a first element is described as being coupled to a second element, the first element may be not only directly coupled to the second element but may also be indirectly coupled to the second element via a third element. In addition, like reference numerals generally refer to like elements throughout.

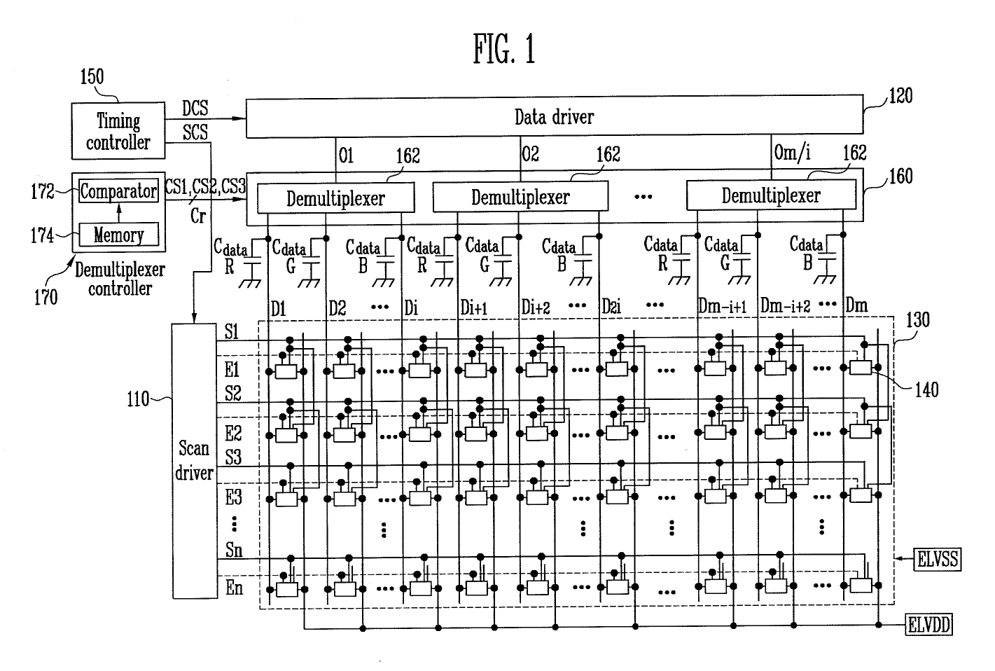

FIG. 1 is a block diagram of an organic light emitting display device according to an embodiment.

The organic light emitting display device of FIG. 1 includes a scan driver 110, a data driver 120, a pixel unit 130, a timing controller 150, a demultiplexer block unit 160, a demultiplexer controller 170 and data capacitors Cdata.

The pixel unit 130 includes a plurality of pixels 140 positioned in areas defined by scan lines S1 to Sn and data lines D1 to Dm. Each of the pixels 140 emits light with a predetermined luminance corresponding to a data signal supplied from a data line D. Each of the pixels 140 is coupled to two scan lines, a data line, a power line for supplying a first power source ELVDD, and an initialization power line (not shown) for supplying an initialization power source. For example, each of the pixels positioned on the last horizontal line is coupled to an (n-1)-th scan line Sn-1, an n-th scan line Sn, a data line D, a power source line and an initialization power line. Meanwhile, a scan line (e.g., a 0-th scan line S0), which is not shown in this figure, is coupled to the pixels 140 positioned on the first horizontal line.

The scan driver 110 generates scan signals in response to a scan driving control signal SCS supplied from the timing controller 150, and sequentially supplies the generated scan signals to the scan lines S1 to Sn.

Further, the scan driver 110 generates emission control signals in response to the scan driving control signal SCS, and sequentially supplies the generated emission control signals to emission control lines E1 to En. In this embodiment, the emission control signals are supplied during at least two horizontal periods.

The data driver 120 generates data signals in response to a data driving control signal DCS supplied from the timing controller 150, and supplies the generated data signals to output lines O1 to Om/i.

The timing controller 150 generates data and scan driving control signals DCS and SCS in response to synchronization signals supplied thereto. The data driving control signal (DCS) generated by the timing controller 150 is supplied to the data driver 120, and the scan driving control signal SCS generated by the timing controller 150 is supplied to the scan driver 110.

The demultiplexer block unit 160 includes m/i demultiplexers 162. In other words, the demultiplexer block unit 160 includes demultiplexers 162 having the same number as that of the output lines O1 to Om/i, and each of the demultiplexer 162 is coupled to one of the output lines O1 to Om/i. Each of the demultiplexers 162 is also coupled i data lines D. The demultiplexers 162 supply i data signals supplied to output lines O to i data lines D during a data period.

If a data signal supplied to one output line O is supplied to i data lines D, the number of output lines O included in the data driver 120 is significantly decreased. For example, if it is assumed that the “i” is 3, the number of output lines O included in the data driver 120 is decreased by a factor of 3 when compared to a conventional data driver. Accordingly, the number of data driving circuits included in the data driver 120 is also decreased. That is, one demultiplexer 162 supplies a data signal from one output line O to i data lines D, thereby saving manufacturing costs.

The demultiplexer controller 170 supplies control signals to each of the demultiplexers 162 during one horizontal period (1H) so that i data signals supplied to the output lines O are supplied to i data lines D. When it is assumed that the “i” is 3, three control signals CS1, CS2 and CS3 may be supplied to each of the demultiplexers 162.

In some embodiments, the demultiplexer controller 170 additionally supplies a reset signal Cr in addition to the i control signals so that a parasitic capacitor on each of the data lines can be initialized.

However, the voltage of the reset signal Cr may be determined based at least in part on a result obtained by comparing the data signal input to each of the pixels during a current horizontal period with a second data signal input to each of the pixels during the previous horizontal period.

That is, when the data signal input to each of the pixels during the previous period is less than the data signal input to each of the corresponding pixels during the current horizontal period, it is unnecessary to initialize the parasitic capacitor on the data line coupled to each of the pixels. Therefore, the reset signal Cr may be selectively not supplied, and accordingly, it is possible to minimize unnecessary switching power consumption.

To perform such an operation, the demultiplexer controller 170 includes a memory 174 for storing data input during at least one previous horizontal period and a comparator 172 for comparing data input to each of the data lines during the previous horizontal period and the data input to each of the data lines during the current horizontal period.

As shown in FIG. 1, the demultiplexer controller 170 is external to the timing controller 150. However, the present invention is not limited thereto. For example, the demultiplexer controller 170 may be part of the timing controller 150.

The parasitic capacitor is a parasitic capacitor formed on each of the data lines. The parasitic capacitors are designated by data capacitors Cdata illustrated in FIG. 1.

The parasitic capacitor stores the data signal supplied to a data line D and supplies the stored data signal to pixels 140. The parasitic capacitor Cdata formed on each of the data lines D generally has a larger capacitance than that of a storage capacitor formed in each of the pixels 140. Hence, the parasitic capacitor can stably store a data signal.

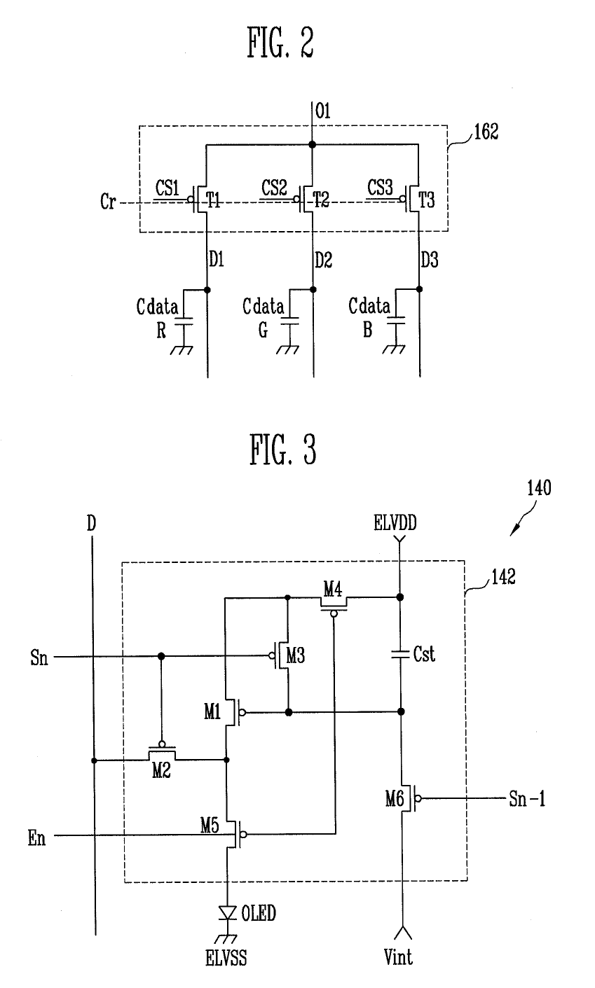

FIG. 2 is an internal circuit diagram of a demultiplexer illustrated in FIG. 1. In FIG. 2, for convenience of illustration, “i” is 3, and the demultiplexer 162 is coupled to a first output line O1. Other configurations can be used.

Referring to FIG. 2, each of the demultiplexers 162 includes a first switching element T1, a second switching element T2 and a third switching element T3.

The first switching element T1 is coupled between the first output line O1 and the first data line D1. When a first control signal CS1 is supplied from the demultiplexer controller 170, the first switching element T1 is turned on to supply a data signal supplied from the first output line O1 to the first data line D1. When the first control signal CS1 is supplied, the data signal supplied to the first data line D1 is arbitrarily stored in a first data capacitor CdataR.

Similarly, the second and third switching elements T2 and T3 are coupled between the first output line O1 and the second data line D2 and between the first output line O1 and the third data line D3, respectively. When second and third control signals CS2 and CS3 are supplied from the demultiplexer controller 170, the second and third switching elements T2 and T3 are turned on to supply data signals supplied from the first output line O1 to the second and third data lines D2 and D3, respectively. That is, when the second and third control signals CS2 and CS3 are supplied, the data signals supplied to the second and third data lines D2 and D3 are stored in second and third data capacitors CdataG and CdataB, respectively.

In some embodiments, a reset signal Cr may be supplied to all three of the switching elements T1, T2, and T3 to turn on all three of the switching elements T1, T2, and T3.

In this case, the reset signal Cr is simultaneously supplied to the first, second and third switching elements before the first, second, and third control signals are sequentially supplied, e.g., at the initialization time of a horizontal period or at a time before the initialization time. If the first, second, and third switching elements T1, T2, and T3 are turned on by the supply of the reset signal Cr, the first, second, and third data capacitors, i.e., the parasitic capacitors on the respective data lines, are initialized by a reset voltage Vr from the first output line.

The reset voltage Vr is less than the voltage of a data signal of the maximum gray scale so as to initialize the parasitic capacitors on the data lines. That is, the initialization voltage is lower than the lowest data voltage supplied from the data driver 120.

However, as described above, when the data signal input to each of the pixels during the previous period is less than the data input to the corresponding pixels during the current horizontal period, it is unnecessary to initialize the parasitic capacitor on the data line coupled to the pixels. Therefore, the reset signal Cr is not supplied.

Accordingly, when the data voltage applied to a data line during the previous period is greater than or equal to the data voltage applied to the data line during the current period, it is necessary to initialize the parasitic capacitor corresponding to the data line. Therefore, the reset signal Cr and the reset voltage Vr are supplied.

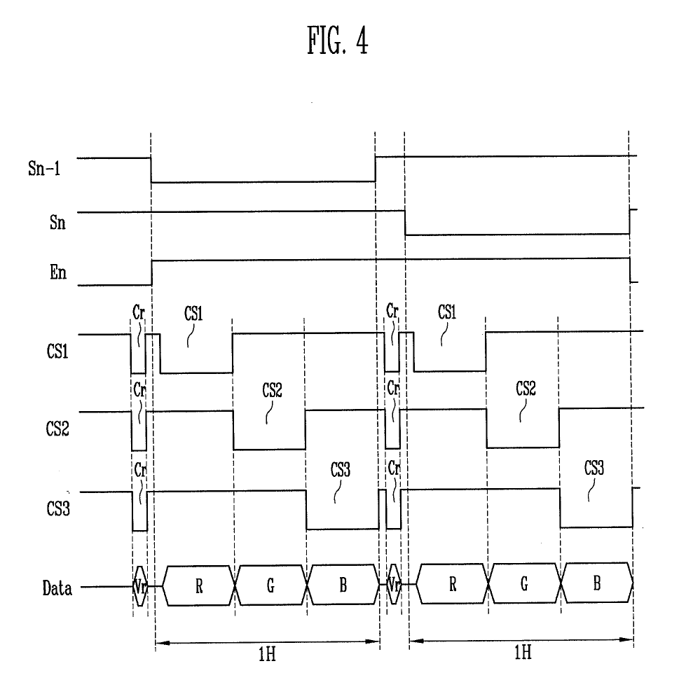

FIG. 3 is a circuit diagram illustrating an embodiment of a pixel illustrated in FIG. 1. The structure of the pixel illustrated in FIG. 3 is an example, and the present invention is not limited thereto.

Referring to FIG. 3, each of the pixels 140 includes an organic light emitting diode OLED, a data line D, a scan line Sn and a pixel circuit 142 connected to an emission control line En to control the organic light emitting diode OLED.

An anode electrode of the organic light emitting diode OLED is coupled to the pixel circuit 142, and a cathode electrode of the organic light emitting diode OLED is coupled to a second power source ELVSS. The second power source ELVSS is e.g., a ground voltage, lower than the first power source ELVDD. The organic light emitting diode OLED emits any one of red, green and blue light corresponding to the amount of current supplied from the pixel circuit 142.

The pixel circuit 142 includes a storage capacitor Cst and a sixth transistor M6, connected between the first power source ELVDD and an initialization power source Vinit; fourth, first and fifth transistors M4, M1 and M5, coupled between the first power source ELVDD and the organic light emitting diode OLED; a third transistor M3 coupled between a gate electrode of the first transistor M1 and a first electrode of the first transistor M1; and a second transistor M2 coupled between the data line D and a second electrode of the first transistor M1.

Here, the first electrode is either of drain and source electrodes, and the second electrode is the other of the drain and source electrodes. For example, if the first electrode is the source electrode, the second electrode is the drain electrode. Although the first to sixth transistors M1 to M6 are shown as P-type MOSFETs in FIG. 5, the present invention is not limited thereto. However, if the first to sixth transistors M1 to M6 are formed as N-type MOSFETs, the polarity of the driving waveform is inverted.

A first electrode of the first transistor M1 is coupled to the first power source ELVDD via the fourth transistor M4, and a second electrode of the first transistor M1 is coupled to the organic light emitting diode OLED via the fifth transistor M5. A gate electrode of the first transistor M1 is coupled to the storage capacitor Cst. The first transistor M1 supplies current corresponding to a voltage charged in the storage capacitor Cst to the organic light emitting diode OLED.

A first electrode of the third transistor M3 is coupled to the first electrode of the first transistor M1, and a second electrode of the third transistor M3 is coupled to the gate electrode of the first transistor Ml. A gate electrode of the third transistor M3 is coupled to an n-th scan line Sn. When a scan signal is supplied to the n-th scan line Sn, the third transistor M3 is turned on so that the first transistor M1 is diode-coupled. That is, when the third transistor M3 is turned on, the first transistor M1 is diode-coupled.

A first electrode of the second transistor M2 is coupled to the data line D, and a second electrode of the second transistor M2 is coupled to the second electrode of the first transistor M1. A gate electrode of the second transistor M2 is coupled to the n-th scan line Sn. When a scan signal is supplied to the n-th scan line Sn, the second transistor M2 is turned on to supply a data signal supplied to the data line D to the second electrode of the first transistor M1.

A first electrode of the fourth transistor M4 is coupled to the first power source ELVDD, and a second electrode of the fourth transistor M4 is coupled to the first electrode of the first transistor M1. A gate electrode of the fourth transistor M4 is coupled to the emission control line En. When a low emission control signal is supplied, the fourth transistor M4 is turned on to allow the first power source ELVDD and the first transistor M1 to be electrically coupled to each other.

A first electrode of the fifth transistor M5 is coupled to the first transistor M1, and a second electrode of the fifth transistor M5 is coupled to the organic light emitting diode OLED. A gate electrode of the fifth transistor M5 is coupled to the emission control line En. When a low emission control signal is supplied, the fifth transistor M5 is turned on to allow the first transistor M1 and the organic light emitting diode OLED to be electrically coupled to each other.

A first electrode of the sixth transistor M6 is coupled to the storage capacitor Cst and the gate electrode of the first transistor M1, and a second electrode of the sixth transistor M6 is coupled to the initialization power source Vinit. A gate electrode of the sixth transistor M6 is coupled to an (n-1)-th scan line Sn-1. When a scan signal is supplied to the (n-1)-th scan line Sn-1, the sixth transistor M6 is turned on to initialize the storage capacitor Cst and the gate electrode of the first transistor M1. To this end, the voltage of the initialization power source Vinit is lower than that of the data signal.

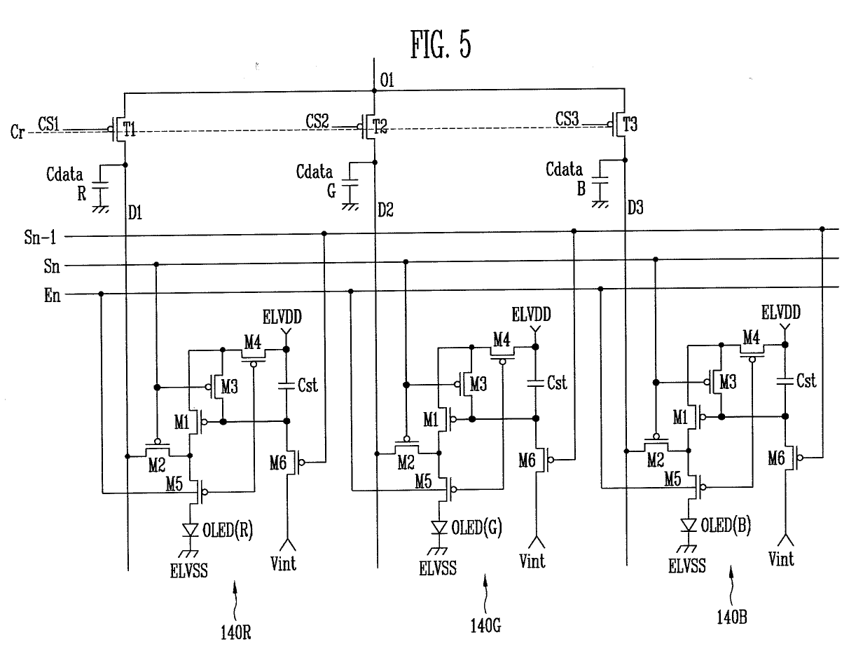

FIG. 4 is a waveform diagram illustrating a driving method of an organic light emitting display device according to an embodiment. FIG. 5 is a circuit diagram illustrating the connection structure of demultiplexers and pixels according to an embodiment of the present invention.

Referring to FIGS. 1 and 4, in the driving method of the organic light emitting display device according to some embodiments, the scan driver 110 sequentially supplies scan signals during respective horizontal periods 1H. The scan driver 110 supplies an emission control signal to overlap with two scan signals.

The demultiplexer controller 170 supplies first, second and third control signals CS1, CS2 and CS3 to overlap with a scan signal during each of the horizontal periods 1H. Here, the first, second and third control signals CS1, CS2 and CS3 are sequentially supplied not to overlap with one another.

The data driver 120 sequentially supplies i data signals R, G and B to the respective output lines O during a period where a scan signal is supplied.

More specifically, when the control signals CS1, CS2 and CS3 are supplied, the data driver 120 supplies the data signals R, G and B to respectively overlap with the control signals CS1, CS2 and CS3. For example, the data driver 120 supplies a red data signal R to overlap with the first control signal CS1 and supplies a green data signal G to overlap with the second control signal CS2. The data driver 120 supplies a blue data signal B to overlap with the third control signal CS3.

As shown, the reset signal Cr is simultaneously supplied before the first to third control signals are sequentially supplied. Accordingly, the reset voltage Vr is applied to each of the data lines to initialize the parasitic capacitor on each of the data lines.

That is, before the respective data signals R, G and B are supplied, the data driver 120 supplies the reset voltage Vr to the output line O so as to overlap with the reset signal Cr.

The reset voltage Vr is used to initialize a voltage charged into a data capacitor Cdata (i.e., a parasitic capacitor) included in each of the data lines D. The voltage of the reset voltage Vr is lower than that of a data signal. In other words, the reset voltage Vr is lower than that of the lowest data voltage supplied from the data driver 120. For example, the reset voltage Vr may be between the lowest the data signal and the voltage of the initialization power source Vinit.

However, in some embodiments, the reset signal Cr and the reset voltage Vr are not always applied. Instead, the application of the reset signal Cr and the reset voltage Vr may, for example, be determined by demultiplexer controller 170 based on the comparison of a data signal input to the pixel during a current horizontal period with that of the data signal input to the pixel during the previous horizontal period.

For example, if the voltage of the data signal input to a pixel during the previous period is less than the voltage of the data input to the corresponding pixel during the current horizontal period, it is unnecessary to initialize the parasitic capacitor on the data line coupled to the pixel. Therefore, the reset signal Cr and the reset voltage Vr are not supplied.

Hereinafter, operation of an embodiment will be described with reference to FIGS. 4 and 5. Pixels 140 coupled to the (n-1)-th scan line Sn-1 and the n-th scan line Sn are illustrated in FIG. 5.

First, a scan signal is supplied to the (n-1)-th scan line Sn-1. If the scan signal is supplied to the (n-1)-th scan line Sn-1, the sixth transistor M6 of the pixels 140R, 140G and 140B is turned on. While the sixth transistor M6 is turned on, one terminal of the storage capacitor Cst and the gate electrode of the first transistor M1 are initialized by the voltage of the initialization power source Vinit.

In addition, a reset signal Cr is supplied before the period where the scan signal is supplied to the (n-1)-th scan line Sn-1. Accordingly, a reset voltage Vr is applied to initialize the parasitic capacitor on each of the data lines, previously charged by the previous data signal.

As a result, the reset voltage Vr overwrites the voltages previously stored in the parasitic capacitors CdataR, CdataG and CdataB (i.e., data capacitors) of the first to third data lines D1 to D3. Accordingly, once a data signal is applied, the pixels can be properly operated because the pixels start from the initialized state.

If the voltage of the data signal applied to a data line during the previous horizontal period is less than that of the data signal applied to the data line during the current horizontal period, the writing of data into each of the pixels can be properly performed even though the data line is not initialized.

Accordingly, in some embodiments, the reset signal Cr and the reset voltage Vr are not always applied, and the supply of the reset signal Cr and the reset voltage Vr may be selectively determined by demultiplexer controller 170, based on the result obtained by comparing the a data signal input to the pixel during a current horizontal period with that of the data signal input to the pixel during the previous horizontal period.

Subsequently, the first, second, and third control signals CS1, CS2, and CS3 are sequentially supplied during the horizontal period after the reset signal Cr is selectively supplied. Then, while the first, second, and third switching elements T1, T2, and T3 are sequentially turned on, data signals are supplied to the data lines D1, D2, and D3. In this case, since a scan signal is not supplied to the n-th scan line Sn, the second transistor M2 of each pixel is turned off, and the data signals are supplied to the data lines D1, D2, and D3, but are not supplied to the pixels 140R, 140G and 140B.

Subsequently, a scan signal is supplied to the n-th scan line Sn during the next horizontal period. If the scan signal is supplied to the n-th scan line, the second and third transistors M2 and M3 included in each of the pixels 140R, 140G and 140B are turned on. While the scan signal is supplied to the n-th scan line Sn, the first, second and third switching elements T1, T2 and T3 are sequentially turned on by the first, second, and third control signals CS1, CS2, and CS3.

While the first switching element T1 is turned on, a red data signal R supplied from the first output line O1 is supplied to the first data line D1 to the pixel 140R via the second transistor M2 in the red pixel 140R. Since the gate electrode of the first transistor M1 in the red pixel 140R is initialized by the initialization power source Vinit, the first transistor M1 in the red pixel 140R is turned on. Because the first transistor M1 in the red pixel 140R is turned on, the red data signal R is supplied to one terminal of the storage capacitor Cst via the first and third transistors M1 and M3 in the red pixel 140R. As a result, a voltage corresponding to the data signal and to the threshold voltage of the first transistor M1 is charged into the storage capacitor Cst.

While the second switching element T2 is turned on by the second control signal CS2, the green data signal G from the first output line O1 is supplied to the pixel 140G via the second transistor M2 in the green pixel 140G. Because the gate electrode of the first transistor M1 in the green pixel 140G is initialized by the initialization power source Vinit, the first transistor M1 in the green pixel 140G is turned on. Because the first transistor Ml in the green pixel 140G is turned on, the green data signal G is supplied to one terminal of the storage capacitor Cst via the first and third transistors M1 and M3 in the green pixel 140G. As a result, a voltage corresponding to the data signal and to the threshold voltage of the first transistor M1 is charged into the storage capacitor Cst.

While the third switching element T3 is turned on by the third control signal CS3, the blue data signal B from the first output line O1 is supplied to the pixel 140B via the second transistor M2 in the blue pixel 140B. Because the gate electrode of the first transistor M1 in the blue pixel 140B is initialized by the initialization power source Vinit, the first transistor M1 in the blue pixel 140B is turned on. Because the first transistor M1 in the blue pixel 140B is turned on, the blue data signal B is supplied to one terminal of the storage capacitor Cst via the first and third transistors M1 and M3 in the blue pixel 140B. As a result, a voltage corresponding to the data signal and to the threshold voltage of the first transistor M1 is charged into the storage capacitor Cst.

As described above, in the driving method of the organic light emitting display device according to some embodiments of the present invention, data signals supplied from one output line O are supplied to i data lines D, thereby saving manufacturing costs. Further, a scan signal is supplied during a horizontal period, and control signals CS1, CS2 and CS3 are sequentially supplied during a time when the scan signal is supplied. Furthermore, desired data signals are supplied during the period when the control signals are supplied, thereby decreasing the supply time of data signals. Accordingly, the charging time of the pixels 140 can be sufficiently secured.

In the driving method of the organic light emitting display device according to some embodiments, the reset voltage Vr supplied from the output line O enables the pixels to be stably driven. In addition, whether to supply the reset signal Cr and the reset voltage Vr to each of the pixels may be determined, for example, by demultiplexer controller 170, based on a comparison of the data signal input to each of the pixels during a current horizontal period with the data signal input to each of the corresponding pixels during the previous horizontal period. As a result, unnecessary switching power consumption can be minimized.

While various aspects have been described in connection with certain exemplary embodiments, it is to be understood that the invention is not limited to the disclosed embodiments, but, on the contrary, is intended to cover various modifications and equivalent arrangements included within the spirit and scope of the specification.

What is claimed is:

1. An organic light emitting display, comprising:
a data driver configured to supply a plurality of data signals and a reset voltage to each of a plurality of output lines;
a plurality of demultiplexers connected to the output lines and a plurality of data lines, each of the output lines corresponding to a plurality of the data lines, wherein each of the demultiplexers has a plurality of switching elements configured to connect each output line to the corresponding data lines;
a demultiplexer controller configured to supply a plurality of control signals and to selectively supply a reset signal to the demultiplexers, the plurality of control signals allowing the data signals of an output line to be applied to the corresponding data lines by sequentially turning on the switching elements, and the reset signal allowing the reset voltage of an output line to be applied to the corresponding data lines by simultaneously turning on the plurality of switching elements;
a scan driver configured to sequentially supply scan signals to scan lines for each of a plurality of horizontal periods; and
a plurality of pixels coupled to the data and scan lines,
wherein the reset signal is selectively supplied to the demultiplexers based at least in part on a comparison of a data signal input to a data line during a current horizontal period with a data signal input to the data line during a previous horizontal period.

2. The organic light emitting display device according to claim 1, wherein the reset signal and the reset voltage are supplied only when the data voltage applied to the data line during the previous period is greater than the data voltage applied to the data line during the current period.

3. The organic light emitting display device according to claim 1, wherein the demultiplexer controller comprises a comparator configured to compare data input to the data line during the current and previous horizontal periods, and a memory for storing data input during at least one horizontal period.

4. The organic light emitting display device according to claim 1, wherein the reset voltage is lower than the voltage of the data signal.

5. The organic light emitting display device according to claim 1, wherein the reset signal is supplied before the plurality of control signals are supplied.

6. The organic light emitting display device according to claim 1, wherein each of the pixels comprises:
an organic light emitting diode;
a storage capacitor for storing a voltage corresponding to the data signal;
a first transistor for supplying current corresponding to the voltage stored by the storage capacitor to the organic light emitting diode;
a second transistor coupled to the data line, a current scan line and a second electrode of the first transistor, the second transistor being turned on when a scan signal is supplied to the current scan line;
a third transistor coupled between a first electrode of the first transistor and a gate electrode of the first transistor, the third transistor being turned on when a scan signal is supplied to the current scan line; and
a sixth transistor coupled between the gate electrode of the first transistor and the data line, the sixth transistor being turned on when a scan signal is supplied to the previous scan line.

7. The organic light emitting display device according to claim 6, further comprising:
a fourth transistor coupled between the gate electrode of the first transistor and the storage capacitor; and
a fifth transistor coupled between the second electrode of the first transistor and the organic light emitting diode.

8. The organic light emitting display device according to claim 7, wherein the fourth and fifth transistors are turned on when an emission control signal is supplied from the scan driver, and turned off otherwise.

9. A method of driving an organic light emitting display device, the method comprising:
applying a reset voltage through each of a plurality of output lines during a horizontal period to supply a reset voltage to a plurality of data lines corresponding to each output line;
initializing a plurality of parasitic capacitors on the data lines with the reset voltage;
sequentially applying a plurality of data signals through each of the output lines to the plurality of corresponding data lines during the horizontal period after initializing the parasitic capacitors;
storing voltages corresponding to the data signals in respective pixels coupled to the plurality of data lines during a period when a scan signal is supplied to a current scan line; and
allowing the pixels to emit light corresponding to the charged voltages,
wherein the reset voltage is selectively supplied to the data lines based at least in part on a comparison of a data signal input to a data line during a current horizontal period with a data signal input to the data line during a previous horizontal period.

10. The driving method according to claim 9, wherein the reset voltage is supplied if the data voltage of the data line during the previous horizontal period is greater than the data voltage applied to the data line during the current horizontal period.

11. The driving method according to claim 9, wherein the voltage of the reset voltage is lower than the voltage of the data signal.

12. An organic light emitting display, comprising a data driver configured to supply a plurality of data signals and a reset voltage to each of a plurality of data lines during a horizontal period, wherein the reset signal is selectively supplied to the data lines based at least in part on a comparison of a data signal input to a data line during a current horizontal period with a data signal input to the data line during a previous horizontal period.

13. The organic light emitting display device according to claim 12, further comprising a plurality of demultiplexers, wherein the data signals and the reset voltage are supplied to the data lines through the demultiplexers.

14. The organic light emitting display device according to claim 12, wherein the reset voltage is supplied only when the data voltage applied to the data line during the previous period is greater than the data voltage applied to the data line during the current period.

15. The organic light emitting display device according to claim 12, further comprising a comparator configured to compare data input to the data line during the current and previous horizontal periods, and a memory for storing data input during at least one horizontal period.

16. The organic light emitting display device according to claim 12, wherein the voltage of the reset voltage is lower than the voltage of the data signal.

17. The organic light emitting display device according to claim 12 wherein the reset voltage is supplied before the plurality of data signals are supplied within a horizontal period.

18. The organic light emitting display device according to claim 12, wherein each of the pixels comprises:
an organic light emitting diode;
a storage capacitor for storing a voltage corresponding to the data signal;
a first transistor for supplying current corresponding to the voltage stored by the storage capacitor to the organic light emitting diode;
a second transistor coupled to the data line, a current scan line and a second electrode of the first transistor, the second transistor being turned on when a scan signal is supplied to the current scan line;
a third transistor coupled between a first electrode of the first transistor and a gate electrode of the first transistor, the third transistor being turned on when a scan signal is supplied to the current scan line; and
a sixth transistor coupled between the gate electrode of the first transistor and the data line, the sixth transistor being turned on when a scan signal is supplied to the previous scan line.

19. The organic light emitting display device according to claim 18, further comprising:
a fourth transistor coupled between the gate electrode of the first transistor and the storage capacitor; and
a fifth transistor coupled between the second electrode of the first transistor and the organic light emitting diode.

20. The organic light emitting display device according to claim 19, wherein the fourth and fifth transistors are turned on when an emission control signal is supplied from the scan driver, and turned off otherwise.
